(19) United States
(12) Patent Application Publication
(10) Pub. No.: US 2022/0032576 A1
(43) Pub. Date: Feb. 3, 2022

(54) Composite Foam Article

(71) Applicant: Proprietect L.P., Toronto (CA)

(72) Inventors: Victoria Jimenez, Woodbridge (CA); Kevin Liping Dong, Woodbridge (CA); Scott D. Wheeler, Stoney Creek (CA); Derrick Smith, Toronto (CA); Wenwei Zhao, Oakville (CA); Le-Cheng Jimmy Lin, Vaughan (CA)

(73) Assignee: Proprietect L.P., Toronto, ON (CA)

(21) Appl. No.: 17/278,834

(22) PCT Filed: Sep. 25, 2019
(86) PCT No.: PCT/IB2019/058146

§ 371 Date: Mar. 23, 2021

Related U.S. Application Data
(60) Provisional application No. 62/798,666, filed on Jan. 30, 2019.
(60) Provisional application No. 62/736,313, filed on Sep. 25, 2018.

(51) Int. Cl. B32B 5/24; B32B 5/18; B32B 7/12; B32B 5/02; B32B 27/12; B32B 27/32; B32B 27/36; B32B 37/06; B32B 37/04; B60N 2/70

(52) U.S. Cl. CPC B32B 5/245; B29C 51/14; B32B 7/12; B32B 5/02; B32B 27/12; B32B 27/32; B32B 27/36; B32B 37/06; B32B 37/04; B60N 2/7035; B32B 2260/021; B32B 2260/046; B32B 2264/108; B32B 2266/0278; B32B 2307/732; B32B 2605/003; B32B 2307/724; B32B 2250/40; B32B 2250/05; B32B 5/18

(57) ABSTRACT

A composite foam article comprises a foam core layer presenting a first surface and a second surface facing opposite the first surface. A first polymeric bonding layer is disposed on the first surface, one or more first reinforcing layers comprising a plurality of fibers and a polymeric binder are disposed on the first polymeric bonding layer, and a first polymeric containment layer is disposed on the one or more first reinforcing layers. A second polymeric bonding layer is disposed on the second surface, one or more second reinforcing layers comprising a plurality of fibers and a polymeric binder are disposed on the second polymeric bonding layer, and a second polymeric containment layer is disposed on the one or more second reinforcing layers. At least one catch layer comprising particles of carbon is dispersed in and/or disposed between any of the aforementioned layers.

### FIELD OF THE DISCLOSURE

The subject disclosure generally relates to a composite foam article. The composite foam article can be used in various automotive interior applications.

### DESCRIPTION OF THE RELATED ART

At one time, the “new car” smell used to be part of the appeal of buying or leasing a new automobile. However, the new car smell is now known to be the result of chemicals emitted from various automotive interior components. More specifically, automotive interior components such as dashboards, interior panels, headliners, seats, etc. are comprised of plastics and other materials that contain various amounts of volatile organic compounds (VOCs) and other chemicals that are emitted into the passenger compartment and create what is known as the new car smell.

There are efforts to reduce concentrations of such VOCs in the confined space of an automobile's passenger compartment to improve the air quality of automotive interiors. As such, it would be advantageous to provide components which reduce VOC emissions and/or absorb VOCs within the passenger compartment.

### SUMMARY OF THE DISCLOSURE AND ADVANTAGES

The subject disclosure provides a composite foam article. A foam core layer presents a first surface and a second surface facing opposite the first surface. A first polymeric bonding layer is disposed on the first surface, one or more first reinforcing layers comprising a plurality of fibers and a polymeric binder is disposed on the first polymeric bonding layer, and a first polymeric containment layer is disposed on the one or more first reinforcing layers. Opposite the first surface, a second polymeric bonding layer is disposed on the second surface, one or more second reinforcing layers comprising a plurality of fibers and a polymeric binder disposed on the second polymeric bonding layer, and a second polymeric containment layer disposed on the one or more second reinforcing layers. At least one catch layer comprising particles of carbon having a surface area of greater than about 300 m²/g is dispersed in and/or disposed between any of the aforementioned layers.

Advantageously, the aforementioned composite article, including the catch layer comprising particles of carbon, reduces VOC emissions and absorbs VOCs within the passenger compartment.

### BRIEF DESCRIPTION OF THE DRAWINGS

The advantages of the present disclosure will be readily appreciated as the same becomes better understood by reference to the following detailed description when considered in connection with the accompanying drawings. It is to be understood that the drawings are purely illustrative and are not necessarily drawn to scale.

FIG. 1 is a perspective view of a vehicle interior including a seat and a headliner including the composite foam article of the subject disclosure.

FIG. 2 is an exploded cross-sectional view of an embodiment of the composite foam article of this disclosure which can be used as an automotive headliner substrate.

FIG. 3 is an exploded cross-sectional view of an embodiment of the composite foam article of this disclosure which can be used as an automotive load floor.

FIG. 4 is an exploded cross-sectional view of an embodiment of the composite foam article of this disclosure which can be used as an automotive seating component.

FIG. 5 is an exploded cross-sectional view of an embodiment of the composite foam article of this disclosure which can be used as an automotive headliner coverstock.

### DETAILED DESCRIPTION OF THE DISCLOSURE

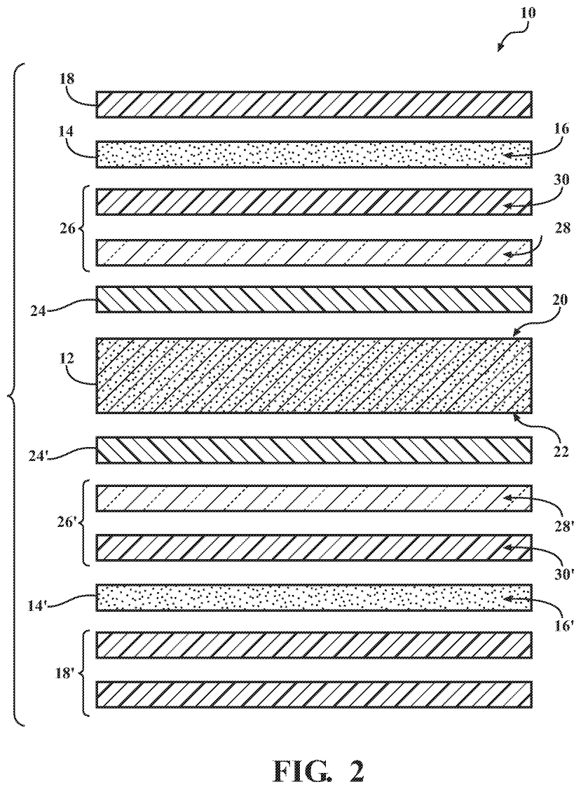

A composite foam article is disclosed herein and generally shown at 10 throughout FIGS. 2-5. The composite foam article 10 includes a foam core layer 12, at least one catch layer 14 comprising particles of carbon 16 having a surface area of greater than about 300 m²/g, and at least one polymeric containment layer 18. In many embodiments, the composite foam article 10 is porous, and its porosity provides: (1) enhanced acoustic properties; and (2) for the capture of volatile organic compounds (“VOCs”) with the catch layer 14.

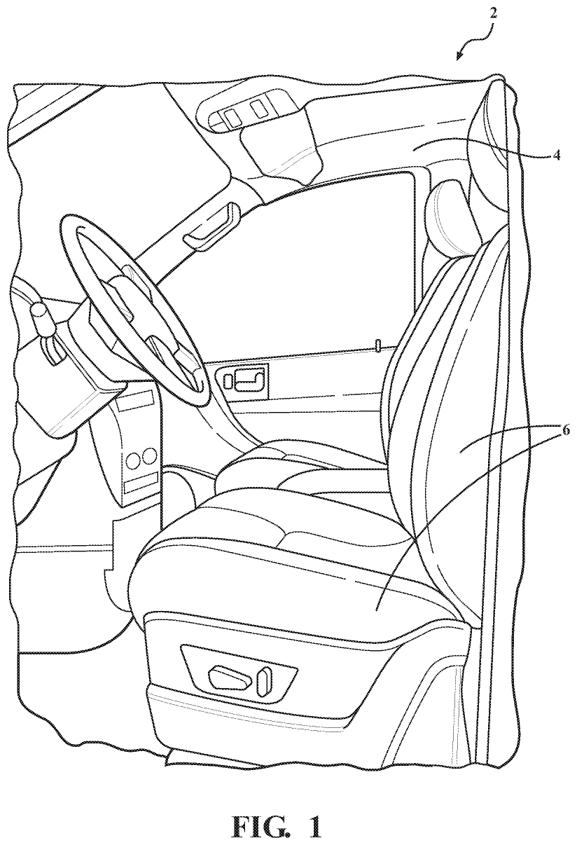

The composite foam article 10 is particularly suitable for use in interior automotive components such as seats, headliners, visors, package trays, load floors, and other vehicular components. When used as or part of an interior automotive component within a vehicle interior 2, e.g. in a headliner 4 or a seat 6 of an automobile as is shown in FIG. 1, the composite foam article 10 emits minimal VOCs and also absorbs VOCs within the passenger compartment of the automobile.

Although the composite foam article 10 of the subject disclosure is particularly useful in the automotive industry, e.g. for use as interior components (e.g. headliners 4 and seats 6) to reduce concentrations of VOCs in the confined space of an automobile's passenger compartment and improve the air quality of automotive interiors 2 as shown in FIG. 1, the composite foam article 10 of the subject disclosure is not limited to use in the automotive industry. As one example, the composite foam article 10 is suitable for use in the aerospace industry, e.g. in airplanes. As another example, the composite foam article 10 is suitable for use in the furniture industry, e.g. in beds, couches, and chairs.

As set forth above, the composite foam article 10 includes the foam core layer 12. The foam core layer 12 presents a first surface 20 and a second surface 22 facing opposite the first surface 20.

The foam core layer 12 includes the reaction product of an isocyanate and an isocyanate-reactive component, e.g. an active hydrogen-containing compound such as a polyol, in the presence of a blowing agent. The foam core layer 12 is an isocyanate-based polymer selected from the group of polyurethane, polyurea, polyisocyanurate, urea-modified polyurethane, carbodiimide-modified polyurethane, urethane-modified polyurea, urethane-modified polyisocyanurate, and urea-modified polyisocyanurate. The term “modified”, when used in conjunction with a polyurethane, polyurea or polyisocyanurate means that up to 50% of the polymer backbone forming linkages have been substituted.

In various embodiments, the foam core layer 12 is a foam type selected from at least one of viscoelastic foam, flexible foam, semi-rigid foam, and rigid foam. For example, in some embodiments, e.g. where the composite foam article 10 is a seat cushion, a seat cover, or a headliner coverstock, the foam core layer 12 may comprise flexible or viscoelastic foam. In other embodiments, e.g. where the composite article 10 is a sun visor, seat back, package tray, load or a headliner substrate, the foam core layer 12 may comprise semi-rigid or rigid foam. Further, the foam core layer 12 can include one or more sublayers of foam. The sublayers may comprise various combinations of the foam types set forth above.

The foam core layer 12 is typically formed via an exothermic reaction of an isocyanate-reactive resin composition (including polyols) and an isocyanate in the presence of a blowing agent. The isocyanate-reactive resin composition, the isocyanate, and the blowing agent, are collectively known as a polyurethane system. Suitable polyurethane foams and polyurethane systems are commercially available from The Woodbridge Group of Woodbridge, ON.

In some embodiments where the foam core layer 12 is a semi-rigid foam, e.g. semi-rigid polyurethane foam for use in headliners and load floors, the composite foam article 10 has an air flow resistance of greater than about 250, greater than about 500, from about 250 to about 7,500, or from about 500 to about 5,000, mks rayls (Pas/m) when tested in accordance with ASTM C522-03. ASTM C522-03 covers the measurement of airflow resistance and the related measurements of specific airflow resistance and airflow resistivity of porous materials that can be used for the absorption and attenuation of sound. ASTM C522-03 is designed for the measurement of values of specific airflow resistance ranging from 100 to 10,000. Of course, in embodiments where the foam core layer 12 is a flexible foam, e.g. flexible polyurethane foam for seat trim or headliner coverstock, the air flow resistance may be lower than 250 inks rayls. In various non-limiting embodiments, all values and ranges of values including and between those described above are hereby expressly contemplated for use herein.

The foam core layer 12 typically has a density of from about 24 to about 180, from about 40 to about 180, from about 24 to about 140, from about 24 to about 100, from about 24 to about 80, from about 45 to about 140, or from about 45 to about 100, kg/m³. In various non-limiting embodiments, all values and ranges of values including and between those described above are hereby expressly contemplated for use herein.

Although density is not a measure of firmness, stiffness, or load bearing capacity, such properties can be characterized by Indentation Force Deflection (IFD) and Compression Force Deflection (CFD). In some embodiments where the foam core layer 12 is a flexible foam, e.g. flexible polyurethane foam for seat trim or headliner coverstock, the foam core layer 12 has: an IFD at 25% deflection of from about 100 to about 2,000, or from about 100 to about 1,000, N/314 cm² when tested in accordance with ASTM D3574-17. In various non-limiting embodiments, all values and ranges of values including and between those described above are hereby expressly contemplated for use herein.

In embodiments where the foam core layer 12 is a semi-rigid foam, e.g. semi-rigid polyurethane foam for use in headliners and load floors, the composite foam article 10 has a CFD at 10% deflection of from about 10 to about 110, or from about 15 to about 90, PSI when tested in accordance with ASTM D3574-17. In various non-limiting embodiments, all values and ranges of values including and between those described above are hereby expressly contemplated for use herein.

It should be appreciated each of the layers described herein can be in included in the composite foam article 10 more than once. It should also be appreciated that each of the different types of layers described herein can include one or more sub layers comprising the materials described herein with respect to that particular layer. Further, the layers described herein can be included in different locations within the composite foam article 10. Of course, the layers can be formed with various combinations of film, powder, particles, and fibers. Various exemplary, non-limiting embodiments are described below which illustrate the use of different numbers of layers in different locations within the composite foam article 10.

As will be apparent when reading the subject disclosure and referencing the corresponding figures (e.g. FIGS. 2-5) a prime after a numeral generally denotes a second of a particular type of layer which is located on an opposite side of the foam core layer 12. For example, the composite foam article 10 typically includes one or more polymeric bonding layers 24. As such, a first polymeric bonding layer 24 could be located on one side of the foam core layer 12 and a second polymeric bonding layer 24′ could be located on the other side of the foam core layer 12 as is illustrated in FIG. 2.

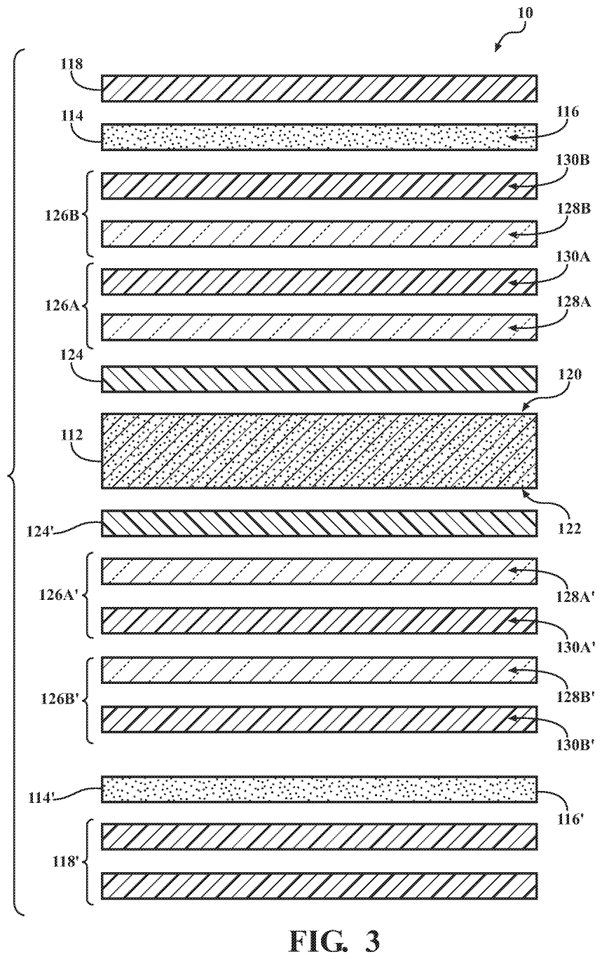

As will be apparent when reading the subject disclosure and referencing the corresponding figures (e.g. FIGS. 2-5) an A, B, etc. after a numeral generally denotes a second of a particular type of layer which is located on the same side of the foam core layer 12. For example, the composite foam article 10 can include one or more reinforcing layers 26. As such, a first and a second reinforcing layer 26A, 26B could be located on one side of the foam core layer 12 as is shown in FIG. 3.

As alluded to above, the composite foam article 10 may include the one or more polymeric bonding layers 24. The polymeric bonding layer 24 is typically disposed on the first and/or second surface 20, 22. Referring now to FIG. 2, in some embodiments, the composite foam article 10 includes a first polymeric bonding layer 24 disposed on the first surface 20, and a second polymeric bonding layer 24′ disposed on the second surface 22.

Of course, the one or more polymeric bonding layers 24 comprise a polymer. In some embodiments, the polymer is a thermoplastic. In other embodiments, the polymer is a thermoplastic elastomer. In other embodiments, the polymer is an elastomer. In some embodiments, the polymer is a thermoset comprising epoxy, polyurethane, polyurea, phenolic, acrylate, arylate, silicone, polysulfide, polyester, and mixtures thereof. Various non-limiting examples of polymers which can be used to form the polymeric bonding layer 24 include polyolefins, polyesters, nylons, poly(vinyl chloride), polyurethanes, polyacrylates, latex, styrene-butadiene polymers, nitrile-butadiene polymers, silicone polymers, mixtures thereof, copolymers thereof and interpenetrating networks thereof.

In some embodiments, the one or more polymeric bonding layers 24 comprise a rubber such as butyl rubber.

Typically, the one or more polymeric bonding layers 24 comprise a polyolefin. In some preferred embodiments, the one or more polymeric bonding layers 24 comprise polyethylene, polypropylene, and combinations thereof. In other preferred embodiments, the one or more polymeric bonding layers 24 comprise polyethylene, polypropylene, butyl rubber, and mixtures thereof. In preferred embodiments, the one or more polymeric bonding layers 24, e.g. the first and/or the second polymeric bonding layers 24, comprise high density polyethylene. The first polymeric bonding layer 24 and/or the second polymeric bonding layer 24 is often formed with film and/or powder.

As alluded to above, the composite foam article 10 may include one or more reinforcing layers 26 comprising a plurality of fibers 28 and a polymeric binder 30. Throughout the figures, the plurality of fibers 28 and the polymeric binder 30 are numbered generally (with an arrow) and are shown as components within the reinforcing layer 26. Referring now to FIG. 2, in some embodiments, the composite foam article 10 includes one or more first reinforcing layers 26 comprising the plurality of fibers 28 and the polymeric binder 30 disposed on the first polymeric bonding layer 24, and one or more second reinforcing layers 26′ comprising the plurality of fibers 28′ and the polymeric binder 30′ disposed on the second polymeric bonding layer 24′.

It should be appreciated that FIGS. 2-5 are not drawn to scale and are for illustrative purposes. To this point, a polymeric bonding layer 24 would typically be thinner than a reinforcing layer, but is not depicted in the Figures as such. Also to this point, the reinforcing layer 26, which includes the plurality of fibers 28 and the polymeric binder 30 is described in that order relative to the core but could also be described in the opposite order (the polymeric binder 30 then the plurality of fibers 28).

The plurality of fibers 28 may be alternatively described as the fibers or the fiber. The plurality of fibers 28 may be woven, non-woven, or any other suitable construction. The plurality of fibers 28 can be naturally occurring or synthetic. The plurality of fibers 28 may include various combinations of the types of fibers set forth.

In various embodiments, plurality of fibers 28 are, include, comprise, consist essentially of, or consist of, a material selected from polymeric, ceramic, glass, metal, mineral, and carbon. In various embodiments, the fibers 28 of the reinforcing layer 26 are, include, comprise, consist essentially of, or consist of: aramid fibers, carbon fibers, cellulose fibers, acrylic fibers, polyvinyl alcohol fibers, glass fibers, mineral fibers, metal fibers, and combinations thereof.

In some embodiments, the plurality of fibers 28 comprise a polymer. That is, the plurality of fibers 28 comprise, consist essentially of, or consist of, a polymer.

In some such embodiments, the plurality of fibers 28 include aramid or aromatic polyamide. In many embodiments, the fibers 28, include, comprise, consist essentially of, or consist of, aromatic polyamide, i.e., aramid. Aramid fibers are a class of heat-resistant and strong synthetic fibers. In some embodiments, the aromatic polyamide is a meta-aramid fiber. In other embodiments, the aromatic polyamide is a para-aramid. The aramid fibers may be pulp or flock of various lengths and diameters.

Aramids are typically formed by reacting amines and carboxylic acid halides. In one embodiment, the aramid is further defined as having at least about 85 percent of amide linkages (—CO—NH—) attached directly to two aromatic rings. In some embodiments, additives can be used with the aramid, and it has been found that up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride of the aramid. To this end, the aramid fibers contemplated and disclosed herein also include aramid copolymers, e.g. polymers including amide and other linkages. In some embodiments, the aromatic polyamide is selected from the group of poly-paraphenylene terephthalamide, poly-meta-phenylene isophthalamide, polyether-polyurea copolymer (elastane), and mixtures thereof.

In some embodiments, the plurality fibers 28 comprise polyester. For example, a terephthalic acid based polyester. Non-limiting examples of terephthalic acid based polyester include poly(ethylene terephthalate) (PET), polybutylene terephthalate (PBT), Polytrimethylene terephthalate (PTT), and Polyethylene naphthalate (PEN). In other embodiments, the plurality of fibers 28 comprise a poly(aromatic ester) selected from the group of poly-paraphenylene terephthalamide, poly-meta-phenylene isophthalamide, polyether-polyurea copolymer (elastane), and mixtures thereof.

In other embodiments, the plurality of fibers 28 comprise mineral or glass. That is, the plurality of fibers 28 comprise, consist essentially of, or consist of a glass. In such embodiments, the plurality of fibers 28 can comprise a glass type selected from at least one of E-glass (alumina-calcium-borosilicate), S2 glass (magnesium-alumino-silicate), C glass (calcium borosilicate), and R glass. In some embodiments, the plurality of fibers 28 can comprise a mineral type selected from at least one of silica, basalt, and quartz.

All weight ranges and ratios of the various combinations of the aforementioned plurality of fibers 28 are hereby expressly contemplated in various non-limiting embodiments.

The polymeric binder 30 can comprise a thermoplastic, a thermoplastic elastomer, or an elastomer. Some non-limiting examples of polymeric binders 30 include epoxies, polyurethanes, polyureas, phenolics, polyacrylates, silicones, polysulfides, polyolefins, polyesters, nylons, polyvinylchlorides, latex, styrene-butadiene polymers, nitrile-butadiene polymers, mixtures thereof, copolymers thereof and interpenetrating networks thereof. In many embodiments, the polymeric binder comprises a polymer selected from polyethylene and polypropylene.

All weight ranges and ratios of the various combinations of the aforementioned polymeric binders are hereby expressly contemplated in various non-limiting embodiments.

If included, in most embodiments, the one or more reinforcing layers 26 are in the form of a porous material layer such as a chopped fiberglass layer, a veil, a mat or the like. The one or more reinforcing layers 26 may comprise or be formed from like or different materials. Typically the one or more reinforcing layers 26 are formed from or comprise like materials, e.g. polymers, fibers, etc.

In a typical embodiment, each of the one or more reinforcing layers 26 comprise a single, porous layer. Alternatively, each of the one or more reinforcing layers 26 can comprise a plurality of porous layers. In such embodiments, it is possible to use from about 2 to about 15 porous layers, from about 2 to about 12 porous layers, from about 2 to about 10 porous layers, from about 2 to about 8 porous layers, or from about 4 to about 8 porous layers.

The composite foam article 10 includes one or more polymeric containment layers 18. The one or more polymeric containment layers 18 function to contain (hold in place) the one or more catch layers 14 described immediately below. The one or more polymeric containment layers 18 can be formed with powder, film, and/or scrim. In a typical embodiment, the composite foam article 10 includes a first polymeric containment layer 18 that is disposed on the one or more first reinforcing layers 26 and a second polymeric containment layer 18′ disposed on the one or more second reinforcing layers 26′. In many embodiments, the one or more polymeric containment layers 18 comprise a polyolefin. In a typical embodiment, the one or more polymeric containment layers 18 comprise a polymer selected from polyethylene and polypropylene.

As set forth above, the composite foam article 10 includes the one or more catch layers 14 comprising particles of carbon 16 having a surface area of greater than about 300 m²/g in the composite foam article 10. Throughout the figures, the particles of carbon 16 are numbered generally (with an arrow) and are shown as components within the catch layer 14 due to their small particulate nature. The one or more catch layers 14 “catch” VOCs, i.e., reduce VOC emissions from the composite foam article 10 and absorb VOCs from within the passenger compartment to improve air quality in the passenger compartment. The one or more catch layers 14 can be dispersed in and/or disposed between any of the aforementioned layers.

In some embodiments, the catch layer 14 is disposed between the one or more reinforcing layers 26 and the one or more polymeric containment layers 18. In some particular embodiments, the at least one catch layer 14 is further defined as a first catch layer 14 and a second catch layer 14′ different than the first catch layer 14. In some such embodiments, the at least one catch layer 14 is further defined as the first catch layer 14, and the first catch layer 14 is disposed between the first reinforcing layer 26 and the first polymeric containment layer 18, and the second catch layer 14′ is disposed between the second reinforcing layer 26′ and the second polymeric containment layer 18′.

The at least one catch layer 14 includes particles of carbon 16 having a surface area of greater than about 300 m²/g. Such high surface area carbon 16 is often referred to as activated carbon, active carbon, or activated charcoal. The particles of carbon 16 have small, low-volume pores that increase the surface area available for adsorption and/or chemical reactions.

Due to its high degree of microporosity, one gram of activated carbon 16 can have a surface area in excess of 3,000 m²/ft. Typically, the surface area of the particles of carbon 16 is determined by gas adsorption. The particles of carbon 16 absorb VOCs solely as a function of high surface area. However, in some embodiments, the particles of carbon 16 can be chemically treated to further enhance its adsorption properties. In some embodiments, the particles of carbon 16 have a surface area of greater than about 300, greater than about 600, greater than about 900, greater than about 1,200, greater than about 1,500, greater than about 1,800, greater than about 2,100, greater than about 2,400, greater than about 2,700, or greater than about 3,000, m²/g. Alternatively, in some embodiments the particles of carbon 16 have a surface area of from about 500 to about 5,000, from about 600 to about 4,500, from about 600 to about 3,500, or from about 700 to about 2,500, m²/g. In various non-limiting embodiments, all values and ranges of values including and between those described above are hereby expressly contemplated for use herein.

The particles of carbon 16 are typically included in the composite foam article 10 in the form of particles or powder, as opposed to in sheet form or some other form. In some embodiments, the particles of carbon 16 have a mean particle size of from about 5 to about 1,000, from about 5 to about 300, from about 10 to about 300, from about 20 to about 250, from about 5 to about 100, from about 5 to about 60, from about 5 to about 35, from about 8 to about 32, or from about 10 to about 60, μm. The mean particle size is the mean particle diameter which is calculated as the size, expressed in μm, for which 50% by weight of granules are smaller. In various non-limiting embodiments, all values and ranges of values including and between those described above are hereby expressly contemplated for use herein.

In some embodiments, the particles of carbon 16 are made from a raw material chosen from at least one of coconut shell, coal, and wood. In one particular embodiment, the particles of carbon 16 are made from coconut shell. Various types of the particles of carbon 16 are commercially available from: Jacobi Carbons, Inc. of Columbus, Ohio, under the tradename ADDSORB™; from Liberty Carbon Service Inc. of Excelsior Springs, Mo.; or from Calgon Carbon Corporation of Pittsburgh, Pa.

In some embodiments, the at least one catch layer 14 comprises carbon in an amount of from about 2 to about 200, from about 2 to about 100, from about 2 to about 50, from about 5 to about 50, or from about 10 to about 40, g/m². In various non-limiting embodiments, all values and ranges of values including and between those described above are hereby expressly contemplated for use herein.

In addition to the particles of carbon 16, the catch layer 14 may include a small molecule scavenger. The small molecule scavenger is added to reduce or eliminate emission of smaller volatile molecules such as formaldehyde and acetaldehyde. In some embodiments, the catch layer 14 further comprises at least one small molecule scavenger selected from zeolite, carbohydrazide, ammonium chloride, functionalized polyols, and urea. In other embodiments, the catch layer 14 further comprises at least one small molecule scavenger chosen from an amine and an amide. The amine small molecule scavenger can include one or more amine groups. The amine groups can be chosen from at least one of a tertiary amine group, a secondary amine group, and a primary amine group. In some preferred embodiments, the catch layer 14 further comprises at least one small molecule scavenger selected from carbohydrazide and urea.

For example, in some embodiments, the catch layer 14 further comprises a zeolite. Zeolites are microporous, aluminosilicate minerals. In one particular embodiment, the catch layer 14 includes particles of carbon 16 and a zeolite.

As another example, in some embodiments, the catch layer 14 comprises a carbohydrazide. Carbohydrazides are chemical compounds with the formula OC(N₂H₃)₂. For purposes of this subject disclosure, derivatives of carbohydrazides, e.g. carbohydrazides where one or more N—H groups are replaced by other substituents are also contemplated for use as small molecular scavengers. In one particular embodiment, the catch layer 14 further comprises carbohydrazide and/or a derivative thereof.

As yet another example, in some embodiments, the catch layer 14 comprises urea. Urea, also known as carbamide, is an organic compound with chemical formula CO(NH₂)₂. This amide has two —NH₂ groups joined by a carbonyl (C═O) functional group. For purposes of this subject disclosure, derivatives of urea are also contemplated for use as small molecular scavengers. In another particular embodiment, the catch layer 14 comprises urea and/or a derivative thereof.

In addition to the particles of carbon 16 and the small molecule scavenger, the catch layer 14 may include various other absorbents, antioxidants, fillers, and other additives.

It should be appreciated that each catch layer 14 included in the composite foam article 10 can have different amounts of carbon and/or small molecule scavenger. So long as the composite foam article 10 includes one catch layer 14 with carbon, additional catch layers, e.g. including a small molecule scavenger and additives can be included.

In some embodiments, the catch layer 14 and the polymeric containment layer 18 are included in the composite foam article 10 in a ratio by weight of from about 3:1 to about 1:3, or about 1:2, respectively.

It should be appreciated that the composite foam article 10 can include additional layers. For example, some embodiments of the composite foam article 10 include additional layers such as a woven or non-woven surface layer. It is also to be appreciated that the composite foam article 10 can have various configurations of layers including different layers on the first surface 20 and its second surface 22, or even layers on one of its surfaces, with its other surface being bonded to a substrate.

A method of forming the composite foam article 10 is also disclosed. Notwithstanding the “dry” process or method disclosed below, it should be appreciated that the composite foam article 10 of the subject disclosure formed with “wet” processes, which are also known in the art, is contemplated herein as well.

In one embodiment, the method includes the steps of:
positioning a blank in a heating device, the blank comprising:
   the polyurethane foam core 12 (as is described above) presenting the first surface 20 and a second surface 22 facing opposite the first surface 20;
   the first polymeric bonding 24 layer disposed on the first surface 20, one or more first reinforcing layers 26 comprising a plurality of fibers and a polymeric binder disposed on the first polymeric bonding layer 24, and a first polymeric containment layer disposed 18 on the one or more first reinforcing layers 26;
   a second polymeric bonding layer 24′ disposed on the second surface 22, one or more second reinforcing layers 26′ comprising the plurality of fibers and the polymeric binder disposed on the second polymeric bonding layer 24′, and the second polymeric containment layer 18′ disposed on the one or more second reinforcing layers 26′; and
   the at least one catch layer 14 comprising particles of carbon having a surface area of greater than about 300 m2/g, the at least one catch layer 14 dispersed in and/or disposed between any of the aforementioned layers;
heating the laminated blank at a temperature above the melting point of the polymeric binder to cause the polymer to melt and the layers of the composite foam article 10 to adhere to one another; and
compressing the laminated blank to form the composite foam article.

In preferred embodiments, the composite foam article includes two catch layers 14, 14′, the first catch layer 14 disposed between the first reinforcing layer 26 and the polymeric containment layer 18 and the second catch layer 14′ disposed between the second reinforcing layer 26′ and the polymeric containment layer 18′.

In a typical embodiment, the step of positioning a blank in a heating device is further described as laminating a blank at a temperature of from about 150 to about 250, or from about 170 to about 230, ° C. In a typical embodiment, the step of laminating can be described as including the sub-step of surface heating the blank (conductive heating). In some embodiments, the step of positioning a blank in a heating device can be described as laminating a headliner substrate.

In a typical embodiment, the method also includes the step of molding the laminated blank into a pre-determined shape (thermoforming). Typically, the step of heating the laminated blank and molding the laminated blank are conducted sequentially.

In a typical embodiment, the laminated blank is then subjected to a temperature of at least about 150° C. in an oven and then transferred to a forming tool at ambient temperatures (about 23° C.) for a period of time sufficient to cause the layers to form the contoured headliner shell shape as defined in the forming tool. In this molding or thermoforming step, facing materials (e.g. knitted fabrics pre-bonded to a thin layer of flexible foam or non-woven scrims) are introduced to become the “A” surface of this contoured headliner shell with the laminated blank serving as a contoured structural core (e.g. headliner substrate). In some embodiments, the steps of heating the laminated blank, compressing the laminated blank, and molding the laminated blank can be described as molding a headliner.

In many embodiments, the heating step in the thermoforming operation is conducted at a temperature of at least about 120, from about 120 to about 250, or from about 150 to about 220, ° C. In various non-limiting embodiments, all values and ranges of values including and between those described above are hereby expressly contemplated for use herein.

Of course, in some embodiments, the blank also includes at least one polymeric bonding layer 24 and/or at least one polymeric containment layer 18. In many embodiments, e.g. embodiments of the method which produce headliner substrates, the composite foam article 10 includes at least two polymeric bonding layers 24, at least two reinforcing layers 26, and at least two polymeric containment layers 18. In such embodiments, the heating step causes a first reinforcing layer 26 to be adhered by the polymer to the first surface 20 of the foam core layer 12 and a second reinforcing layer 26′ to be adhered by the polymer to the second surface 22 of the foam core layer 12. Further in some such embodiments, the composite foam article 10 includes at least two catch layers 14, 14′.

In some embodiments of the method, the steps above are repeated to produce multiple composite foam articles 10. The composite article 10 can be stacked and wrapped (e.g. stretch-wrapped) in to reduce exposure to air, this further reduces VOC emissions, including emissions of low molecular weight VOCs.

Many of the method steps described herein are included in U.S. Patent Application Publication No. 2008/0311336, which is incorporated herein in its entirety.

### Headliner Substrates

In one embodiment, the composite foam article 10 is an automotive headliner substrate. As is illustrated in FIG. 1, automotive headliners 4 are used to line the roof of the automobile. Conventionally, an automotive headliner is the composite foam article 10 (headliner) comprising, for example, a foam core 12 and multiple layers and sometimes including a cover material or headliner coverstock. As is described below, the composite foam article 10 can also be utilized as headliner coverstock. The headliner coverstock comprises a finished outer surface that faces the interior 2 of the automobile and is disposed adjacent or is comprised in the so-called A-surface (first as described herein) of the headliner. The surface of the headliner adjacent the A-surface is the so-called B-surface (second as described herein). The B-surface of the headliner may or may not comprise a headliner coverstock. The layers which can be included in the headliner substrates (and headliner coverstock) are described above.

Referring now to FIG. 2, in some embodiments, the composite foam article 10 (e.g. headliner) includes the foam core layer 12 presenting the first surface 20 and the second surface 22 facing opposite the first surface 20. The first polymeric bonding layer 24 is disposed on the first surface 20, one or more first reinforcing layers 26 comprising the plurality of fibers 28 and the polymeric binder 30 is disposed on the first polymeric bonding layer 24, and the first polymeric containment layer 18 is disposed on the one or more first reinforcing layers 26. Opposite the first surface 20, the second polymeric bonding layer 24′ is disposed on the second surface 22, one or more second reinforcing layers 26′ comprising the plurality of fibers 28′ and the polymeric binder 30′ disposed on the second polymeric bonding layer 24′, and the second polymeric containment layer 18′ disposed on the one or more second reinforcing layers 26′. The at least one catch layer 14 comprising particles of carbon 16 having the surface area of greater than about 300 m²/g is dispersed in and/or disposed between any of the aforementioned layers.

In such embodiments, the foam core layer 12 is just as described above. By way of further explanation, automotive headliners are typically produced from isocyanate-based foams (such as those described above) such as polyurethane foams. When producing automotive headliners from polyurethane foams, it is conventional to utilize the so-called free-rise or slab polyurethane foams. In some embodiments, the foam core layer 12 is produced by dispensing the isocyanate-reactive resin composition (including polyols) and the isocyanate in the presence of a blowing agent into a trough having an open top (also known as a tunnel) and a conveyor bottom to move the mixture away from the mix head as the foam rises. Low pressure mixing is typically used and involves metering the components for foam production into a mix head mixing, and forming polyurethane foam slabstock, e.g. to be used in some embodiments as the foam core layer 12. The properties of the resulting foam can be adjusted by varying the nature and/or amount of one or more of the metered components.

In some embodiments, slabstock polyurethane foam is produced for the polyurethane foam core 12 in manufacturing facilities in the form of foam “buns” having dimensions such as 4 feet (height)×6 feet (width)×100 feet (length). Each bun is then cut into a plurality of shorter length (e.g. 8 feet) buns, depending on the specifications of the particular automotive headliner being produced. The shorter length bun is then sliced into sheets of appropriate thickness (e.g. from about 2 to about 12 mm).

Once the foam core layer 12 is formed, layers such as those described above can be added, and various other trimming and further processing steps, e.g. lamination and molding are typically conducted. For example, the composite foam article 10 can be thermoformed to confer to the planar sheet a slightly contoured appearance which more closely assumes the shape of the roof of the automobile.

The first polymeric bonding layer 24 is disposed on the first surface 20, one or more first reinforcing layers 26 comprising the plurality of fibers 28 and the polymeric binder 30 is disposed on the first polymeric bonding layer 24, and the first polymeric containment layer 18 is disposed on the one or more first reinforcing layers 26. Opposite the first surface 20, the second polymeric bonding layer 24′ is disposed on the second surface 22, one or more second reinforcing layers 26′ comprising the plurality of fibers 28 and the polymeric binder 30 disposed on the second polymeric bonding layer 24′, and the second polymeric containment layer 18′ disposed on the one or more second reinforcing layers 26′.

In some embodiments, including headliner substrate embodiments, the foam core layer 12 has a thickness (T) of from about 2 to about 15, from about 3 to about 12, or from about 4 to about 10, mm. In various non-limiting embodiments, all values and ranges of values including and between those described above are hereby expressly contemplated for use herein.

Referring again to FIG. 2, an exploded cross-sectional view of one embodiment of the composite foam article 10 which can be utilized as a headliner is illustrated. In the embodiment of FIG. 2, the composite foam article 10 (e.g. headliner) includes the foam core layer 12 comprising a semi-rigid polyurethane foam which presents the first surface 20 and the second surface 22 facing opposite the first surface 20. The first polymeric bonding layer 24 comprising the high density polyethylene film is disposed on the first surface 20, the first reinforcing layer 26 comprising the plurality of fiberglass fibers 28 and the polypropylene polymeric binder 30 is disposed on the first polymeric bonding layer 24, the first catch layer 14 comprising particles of carbon 16 (e.g. in amounts of about 10 to about 100 g/m²) is disposed on the first reinforcing layer 26, and the first polymeric containment layer 18 comprising polypropylene scrim is disposed on the first catch layer 14. Opposite the first surface 20, the second polymeric bonding layer 24′ comprising a high density polyethylene film is disposed on the second surface 22, the second reinforcing layer 26′ comprising the plurality of glass fibers 28′ and the polypropylene polymeric binder 30′ is disposed on the second polymeric bonding layer 24′, the second catch layer 14′ comprising particles of carbon 16′ (e.g. in amounts of about 10 to about 100 g/m²) is disposed on the second reinforcing layer 26′, and the second polymeric containment layer 18′ comprising sub layers of polypropylene scrim and polyethylene terephthalate scrim is disposed on the second reinforcing layer 26′. High density polyethylene, polyethylene terephthalate, polypropylene in the form of powder, scrim and/or film can be employed.

Those of skill in the art understand that the layers of the embodiments of the composite foam articles 10 in FIG. 2 and described elsewhere herein intermingle as a result of the lamination process such that there may be a gradual interface between the layers as a result of the melting of the polymeric materials in the composite foam article 10 and the subsequent lamination and molding of the layers.

### Load Floors

In one embodiment, the composite foam article 10 is an automotive load floor. Load floors often have a configuration similar to that of a headliner, but include additional layers because load floors require additional strength. Conventionally, an automotive load floor is a composite foam article 10 (laminate structure) comprising, for example, the foam core layer 12 and multiple other layers.

Referring now to FIG. 3, an expanded cross-sectional view of one embodiment of the composite foam article 10 which can be utilized as a load floor is illustrated. In the embodiment of FIG. 3, the composite foam article 10 (e.g. load floor) includes the foam core layer 112 comprising a semi-rigid polyurethane foam which presents the first surface 120 and the second surface 122 facing opposite the first surface 120. The first polymeric bonding layer 124 comprising the high density polyethylene film is disposed on the first surface 120, the first reinforcing layer 126A comprising the plurality of fiberglass fibers 128A and the polypropylene polymeric binder 130A is disposed on the first polymeric bonding layer 124, an additional first reinforcing layer 126B comprising the plurality of fiberglass fibers 128B and the polypropylene polymeric binder 130B is disposed on the first reinforcing layer 126A, the first catch layer 114 comprising particles of carbon 116 (e.g. in amounts of about 10 to about 100 g/m²) is disposed on the first additional reinforcing layer 126B, and the first polymeric containment layer 118 comprising polypropylene is disposed on the first catch layer 114. Opposite the first surface 120, the second polymeric bonding layer 124′ comprising a high density polyethylene film is disposed on the second surface 122, the second reinforcing layer 126A′ comprising the plurality of glass fibers 128A′ and the polypropylene polymeric binder 130A′ is disposed on the second polymeric bonding layer 124′, an additional second reinforcing layer 126B′ comprising the plurality of fiberglass fibers 128B′ and the polypropylene polymeric binder 130B′ is disposed on the second reinforcing layer 126A′, the second catch layer 114′ comprising particles of activated carbon 116 (e.g. in amounts of about 10 to about 100 g/m²) is disposed on the second additional reinforcing layer 126B′, and the second polymeric containment layer 118′ comprising polypropylene powder and polypropylene scrim is disposed on the second additional reinforcing layer 126B′. High density polyethylene, polyethylene terephthalate, polypropylene in the form of powder, scrim and/or film can be employed.

In some embodiments, including load floor embodiments, the foam core layer 12 has a thickness (T) of from about 4 to about 30, from about 10 to about 26, or from about 12 to about 20, mm. In various non-limiting embodiments, all values and ranges of values including and between those described above are hereby expressly contemplated for use herein.

### Seat Trim & Components

In some embodiments, the composite foam article 10 is used in/is a seat component, e.g. seat trim. To this end, the composite foam article 10 may be a seating component and referred to as such. As used throughout this disclosure, the term “seat component” is used in connection with one, some or all of a cushion (i.e., the portion of the seat on which the occupant/passenger sits), a back or back rest (i.e., the portion of the seat which supports the back of the occupant/passenger) and a side bolster (i.e., the extension of the cushion, back or the back rest, which laterally supports the occupant/passenger).

For example, in some embodiments, the composite foam article 10 is a seat component comprising:
the foam core layer 12 presenting the first surface 20 and the second surface 22 facing opposite the first surface 20;
the polymeric bonding layer 24 optionally disposed on the first surface 20;
the catch layer 14 comprising particles of carbon 16 having a surface area greater than about 500 m²/g disposed on the first surface 20 (or the polymeric bonding layer 24);
the polymeric containment layer 18 disposed on the catch layer 14; and
the non-woven, woven, leather, or vinyl layer (seat cover) may be disposed on the second surface 22.

In many seating embodiments, the composite foam article 10 comprises a flexible and/or a viscoelastic polyurethane foam.

Further, in such seating embodiments, the non-woven, woven, leather, or vinyl layer may be flame bonded to the second surface 22. In such embodiments, the composite foam article 10 has a total thickness of from about 1 to about 10, mm post flame bonding.

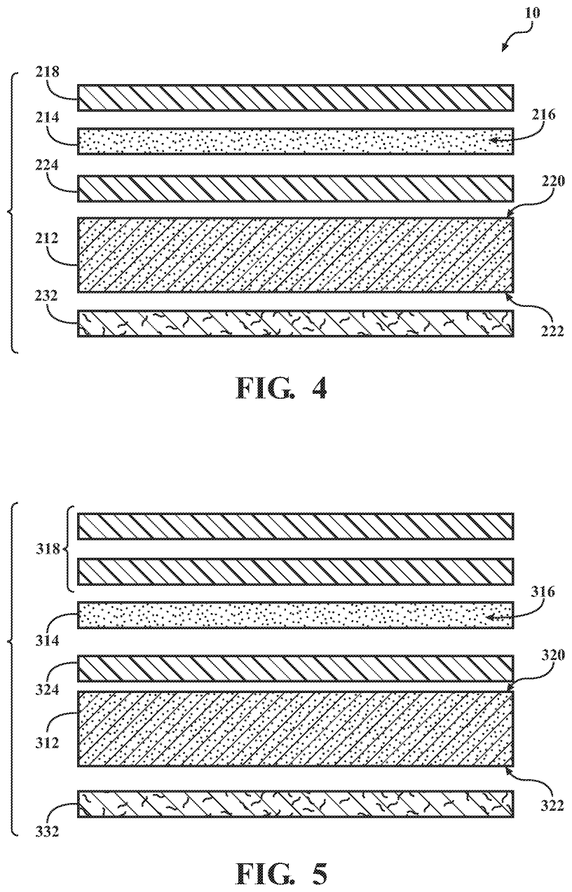

Referring now to FIG. 4, an expanded cross-sectional view of one embodiment of the composite foam article 10 which can be utilized as a seat component is illustrated. In the embodiment of FIG. 4, the composite foam article 10 (e.g. seat cover) includes the foam core layer 212 comprising a flexible and/or a viscoelastic polyurethane foam and presenting the first surface 220 and the second surface 222 facing opposite the first surface 220. The first polymeric bonding layer 224 comprising the high density polyethylene is optionally disposed on the first surface 220. The catch layer 214 comprising particles of carbon 216 (e.g. in an amount of from about 10 to about 100 g/m²) is disposed on the first surface 220 or the first polymeric bonding layer 224, the polymeric containment layer 218 comprising one or more layers of polymer (e.g. polyethylene) film is disposed on the catch layer 214; and the non-woven, woven, leather, or vinyl layer (e.g. seat cover) 232 is disposed on the second surface 222. High density polyethylene, polyethylene terephthalate, polypropylene in the form of powder, scrim and/or film can be employed in various sub-layers.

### Headliner Coverstock

In some embodiments, the composite foam article 10 is used in/is headliner coverstock. Referring now to FIG. 5, an expanded cross-sectional view of one embodiment of the composite foam article 10 which can be utilized as a headliner coverstock is illustrated. In the embodiment of FIG. 5, the composite foam article 10 (e.g. headliner coverstock) includes the foam core layer 312 comprising a flexible and/or a viscoelastic polyurethane foam and presenting the first surface 320 and the second surface 322 facing opposite the first surface 320. The first polymeric bonding layer 324 comprising the high density polyethylene is optionally disposed on the first surface 320. The catch layer 314 comprising particles of carbon 316 is disposed on the first polymeric bonding layer 324 (e.g. in an amount of from about 10 to about 100 g/m²), the polymeric containment layer 318 comprising a polyethylene sublayer and a polyethylene terephthalate sub layer is disposed on the catch layer 314; and the non-woven, woven, leather, or vinyl layer (e.g. headliner cover) 332 is disposed on the second surface 322. High density polyethylene, polyethylene terephthalate, polypropylene in the form of powder, scrim and/or film can be employed in various sub layers.

### Other Applications

It is to be appreciated that the layers described above can be used in any combination, as long as they include the foam core layer 12, the catch layer 14, and the polymeric containment layer 18. Various composite foam articles 10 contemplated herein include laminates for use as headliners, load floors, seat components, sun shades, sun visors, rear seat back panels, and package trays comprising various combinations of the layers described.

The following examples are intended to illustrate the present disclosure and are not to be read in any way as limiting to the scope of the present disclosure.

### EXAMPLES

Examples of the composite foam article are described in automotive applications below. Generally, the Examples show how the composite foam article of the subject disclosure generate less VOCs than comparative composite foam articles.

The general construction of the composite foam article of the headliner substrates (sandwich structure) of Examples 1 and 2 are shown in FIG. 1. Examples 1 and 2 include particles of carbon made from coconut shell that are commercially available from Jacobi Carbons, Inc. of Columbus, Ohio, under the tradename ADDSORB™. Table 1 below describes the reduction in VOCs which is achieved with the composite foam articles of Examples 1 and 2 relative to the VOC emissions of Comparative Examples 1 and 2. The VOC testing is conducted by placing a sample (12″×12″×sample thickness) in a 100 L non-emitting plastic bag (e.g. made from TEDLAR® or MYLAR®), a gas is applied and the bag sealed. After a period of incubation (2 hours at 65° C.), the static headspace is then pumped out of the bag (at sampling flow Rate 800 ml/min and a sampling volume 10 L (DNPH Cartridge) onto a sorbent-packed TD tube (N₂; 3 L) for analysis by TD-GC-MS and/or GCMS and/or HPLC. The VOC testing results in Table 1 are in μg/m³.

TABLE 1

| | Comparative | Comparative | Example 1 | Example 2 |
|---|---|---|---|---|
| | Example 1 | Example 2 | (10 g/m² | (20 g/m² |
| Results | (Foam | (No Catch | activated | activated |
| in μg/m³ | Only) | Layers) | carbon) | carbon) |
| Formaldehyde | 323.5 | 69.5 | 324.5 | 47.5 |
| Acetaldehyde | 92 | 193.5 | 410 | 174.5 |
| Acetone | 48.5 | 256.5 | 206.5 | 154.5 |
| Propaldehyde | 94.5 | 212.5 | 62 | ND |
| Sum of | 587 | 725.5 | 1030 | 368 |
| Aldehydes and | | | | |
| Ketones | | | | |
| Toluene | 607 | 192 | 8.5 | ND |
| Xylene | 12 | 56.5 | ND | ND |
| Ethylbenzene | ND | 12.5 | ND | ND |
| Styrene | 81.5 | 49.5 | ND | ND |
| Sum of | 938 | 440 | 8.5 | ND |
| aromatic | | | | |
| substances | | | | |
| Total VOC | 3236 | 4314.5 | 765 | 5.5 |

ND - Not Detectible

Referring now to Table 1 above, Examples 1 and 2, which include two catch layers, significantly reduce VOC emissions. Further, as the content of particles of carbon within the catch layers increase, VOC emissions are reduced further. These results indicate that significant reductions in aromatics and total VOCs are achieved by adding a layer of activated carbon. Higher levels of activated carbon (20 g/m²) perform better than lower levels of activated carbon (10 g/m²).

The general construction of the composite foam article of the headliner substrates (sandwich structure) of Examples 3 and 4 are shown in FIG. 1. Example 3 includes particles of carbon having mean diameter (D50) of about 34 microns, which are made from coal and wood and are commercially available from Liberty Carbon Service Inc. of Excelsior Springs, Mo. Example 4 includes particles of carbon having mean diameter (D50) of about 10 microns, which are made from coconut shells and are commercially available from Calgon Carbon Corporation of Pittsburgh, Pa. The particles of carbon of Example 4 are granular particles which were pulverized to a mean diameter (D50) of approximately 10 microns. Table 2 below describes the reduction in VOCs which is achieved with the composite foam articles of Examples 3 and 4 relative to the VOC emissions of Comparative Example 3. The VOC testing is conducted in accordance to the method set forth above (65° C., 2 hours, 100 L bag) and results are in μg/m³.

TABLE 2

| | | Example 3 | Example 4 |
|---|---|---|---|
| | | (15 g/m² | (15 g/m² |
| | | activated | activated carbon; |
| | Comparative | carbon; mean | mean diameter |
| | Example 3 | diameter | (D50) of |
| Results | (No Catch | (D50) of about | approximately |
| in μg/m³ | Layer) | 34 microns) | 10 microns) |
| Formaldehyde | 46 | 24 | 19 |
| Acetaldehyde | 200 | 32 | 22 |
| Acetone | 206 | 23.5 | 12 |
| Propaldehyde | 357 | ND | ND |
| Sum of | 872 | 79 | 54 |
| Aldehydes and | | | |
| Ketones | | | |
| Toluene | 87 | ND | ND |
| Xylene | 13 | ND | ND |
| Ethylbenzene | ND | ND | ND |
| Styrene | ND | ND | ND |
| Sum of | 462 | ND | 11 |
| aromatic | | | |
| substances | | | |
| Total VOC | 4851 | 171 | 398 |

ND - Not Detectible

Referring now to Table 2 above, Examples 3 and 4, which include a catch layer, significantly reduce VOC emissions. The particles of carbon within the catch layer of Examples 3 and 4 significantly reduce VOCs relative to Comparative Example 3. The results shown in table 2 indicate that the type of carbon chosen impacts performance as Examples 3 and 4 provide much improved reductions in aldehydes relative to Examples 1 and 2 in Table 1.

The general construction of the composite foam article of the seat covers (flexible foam laminate) of Examples 5 and 6 are shown in FIG. 3. Examples 5 and 6 were prepared using the activated carbon ground to a mean diameter of about 150 μm that is commercially available from Calgon Carbon Corporation of Pittsburgh, Pa. Table 3 below describes the reduction in VOCs which is achieved with the composite foam articles of Examples 5 and 6 relative to the VOC emissions of Comparative Example 4. The VOC testing is conducted in accordance to the method set forth above (65° C., 2 hours, 100 L bag) and results are in μg/m³.

TABLE 3

| | Comparative | Example 5 | Example 6 |
|---|---|---|---|
| | Example 4 | (10 g/m² | (20 g/m² |
| Results | (No Catch | activated | activated |
| in μg/m³ | Layer) | carbon) | carbon) |
| Formaldehyde | 32 | 50.5 | 64 |
| Acetaldehyde | 5.5 | 12 | 15.5 |
| Acetone | ND | 16.5 | 23 |
| Propaldehyde | 89.5 | 14.5 | 27.5 |
| Sum of | 126.5 | 93.5 | 135.5 |
| Aldehydes and | | | |
| Ketones | | | |
| Toluene | ND | ND | ND |
| Xylene | ND | ND | ND |
| Ethylbenzene | ND | ND | ND |
| Styrene | ND | ND | ND |
| Sum of | 241.5 | 4 | 4 |
| aromatic | | | |
| substances | | | |
| Total VOC | 1121 | 186.5 | 49.5 |

ND - Not Detectible

Referring now to Table 3 above, Examples 5 and 6, which include a catch layer, significantly reduce VOC emissions. Further, as the content of particles of carbon within the catch layer increase, VOC emissions are reduced further.

The general construction of the composite foam article of the headliner substrates (sandwich structure) of Examples 7 and 8 are generally shown in FIG. 1 (there is no difference in the construction of these exemplary composite foam articles) but also include coverstock. Examples 7 and 8 were prepared using the activated carbon ground to a mean diameter of about 150 μm that is commercially available from Calgon Carbon Corporation of Pittsburgh, Pa. Comparative examples 5 and 6 are also formed headliner substrate including coverstock, but these do not contain any layers of activated carbon. Tables 4 and 5 below describes the reduction in VOCs which is achieved with the composite foam articles of Examples 7 and 8 relative to the VOC emissions of Comparative Examples 5 and 6 after 1 week and 4 months, respectively. Formed Headliners were stored in the general warehouse area and are exposed to plant environment. The VOC testing is conducted in accordance to the method set forth above (65° C., 2 hours, 100 L bag). Referring now to Table 4 below, the results generated were generated 1 week after the composite foam articles of Examples 7 and 8 were formed and are set forth in μg/m³.

TABLE 4

| | Comparative | Comparative | Example 7 | Example 8 |
|---|---|---|---|---|
| | Example 5 | Example 6 | (10 g/m² | (10 g/m² |
| DPNH Cartridge | (No Catch | (No Catch | activated | activated |
| Data | Layer) | Layer) | carbon) | carbon) |
| Formaldehyde | 68 | 67 | 57 | 52 |
| Acetaldehyde | 130 | 120 | 47 | 48 |
| Acrolein | ND | ND | ND | ND |
| Acetone | 174 | 164 | 29 | 27 |
| Butanone (MEK) | ND | ND | ND | ND |
| Propaldehyde | 139 | 127 | ND | ND |
| Butyraldehyde | 11 | ND | ND | ND |
| Crotonaldehyde | ND | ND | ND | ND |
| Methacrolein | ND | ND | ND | ND |
| Benzaldehyde | ND | 10 | ND | ND |
| Hexanaldehyde | ND | ND | ND | ND |
| Sum of Aldehydes | 522 | 488 | 133 | 127 |
| and Ketones | | | | |

TD Tube Data

| | | | | |
|---|---|---|---|---|
| Benzene | ND | ND | ND | ND |
| Toluene | 38 | 39 | ND | ND |
| Xylene | 11 | 11 | ND | ND |
| Ethylbenzene | ND | ND | ND | ND |
| Styrene | ND | ND | ND | ND |
| Sum of Aromatic | 103 | 107 | ND | ND |
| Substances | | | | |
| Total VOC | 938 | 742 | 9 | 6 |

ND - Not Detectible

Referring now to Table 5 below, the results generated were generated 4 months after the composite foam articles of Examples 6 and 7 were formed and are set forth in μg/m³.

TABLE 5

| | Comparative | Comparative | Example 7 | Example 8 |
|---|---|---|---|---|
| | Example 5 | Example 6 | (10 g/m² | (10 g/m² |
| DPNH | (No Catch | (No Catch | activated | activated |
| Cartridge Data | Layer) | Layer) | carbon) | carbon) |
| Formaldehyde | 543 | 536 | 526 | 504 |
| Acetaldehyde | 2296 | 2256 | 1160 | 1120 |
| Acrolein | ND | ND | 22 | 19 |
| Acetone | 161 | 163 | 117 | 116 |
| Butanone | 43 | 22 | 24 | 47 |
| (MEK) | | | | |
| Propaldehyde | 1016 | 999 | 50 | 49 |
| Butyraldehyde | 28 | 28 | ND | ND |
| Crotonaldehyde | 34 | 31 | 18 | 20 |
| Methacrolein | 78 | 79 | ND | ND |
| Benzaldehyde | 12 | 14 | ND | ND |
| Hexanaldehyde | 43 | 35 | ND | ND |
| Sum of | 4255 | 4164 | 1917 | 1875 |
| Aldehydes and | | | | |
| Ketones | | | | |

TD Tube Data

| | | | | |
|---|---|---|---|---|
| Benzene | ND | ND | 8 | 8 |
| Toluene | 137 | 132 | ND | ND |
| Xylene | 23 | 22 | ND | ND |
| Ethylbenzene | 5 | 5 | ND | ND |
| Styrene | ND | ND | ND | ND |
| Sum of | 381 | 369 | 12 | 11 |
| Aromatic | | | | |
| Substances | | | | |
| Total VOC | 1808 | 1770 | 19 | 17 |

ND - Not Detectible

Referring now to Tables 4 and 5 above, Examples 7 and 8, which include a catch layer, significantly reduce VOC emissions. Table 5, when compared to Table 4, indicates headliner emissions increase when they are stored in a plant environment fully exposed to ambient air for a longer periods of time (4 months vs. 1 week). Table 5 also indicates that activated carbon significantly reduces or eliminates total VOC and aromatic emissions but is less effective for smaller molecule aldehydes such as formaldehyde and acetaldehyde.

Referring now to Table 6 above, Examples 9 and 10, which include a catch layer comprising activated and carbon respectively, reduce the emission of smaller volatile molecules such as formaldehyde.

The general construction of the composite foam article of the headliner substrates (sandwich structure) of Examples 9 and 10 are shown in FIG. 1. The catch layers of the composite foam article of Example 9 include activated carbon having a mean diameter of about 150 and commercially available from Calgon Carbon. The catch layers of the composite foam article of Example 10 include activated carbon and carbohydrazide.

Table 6 below describes the reduction in VOCs which is achieved with the composite foam articles of Example 9 and especially Example 10 relative to the VOC emissions of Comparative Example 7. The VOC testing is conducted in accordance to the method set forth above (65° C., 2 hours, 100 L bag). Referring now to Table 6 below, the results generated are set forth in μg/m³.

TABLE 6

| | | | Example 10 |
|---|---|---|---|
| | | | (15 gsm |
| | Comparative | Example 9 | Activated |
| | Example 7 | (15 gsm | Carbon and |
| | (No Catch | Activated | 2 gsm |
| | Layer) | Carbon) | carbohydrazide) |
| Formaldehyde | 35 | 26 | 13 |
| Acetaldehyde | 331 | 55 | 60 |
| Acetone | 144 | 40 | 54 |
| Propaldehyde | 289 | ND | ND |
| Benzaldehyde | 57 | ND | ND |

ND - Not Detectible

Referring now to Table 6 above, Examples 9 and 10, which include a catch layer, significantly reduce VOC emissions over Comparative Example 7. Further, the catch layer of Example 10, which includes activated carbon and carbohydrazide (an additional small molecule scavenger) more effectively reduces the emission of smaller volatile molecules such as formaldehyde.

The general construction of the composite foam article of the headliner substrates (sandwich structure) of Example 11 is shown in FIG. 1 and includes two catch layers comprising activated carbon. The headliner substrate of Example 12 is just like that of Example 11 but includes a single catch layer (as opposed to two).

Table 7 below describes the reduction in VOCs which is achieved with the composite foam articles of Example 11 and especially Example 12 relative to the VOC emissions of Comparative Example 8. The VOC testing is conducted in accordance to the method set forth above (65° C., 2 hours, 100 L bag). Referring now to Table 7 below, the results generated are set forth in μg/m³. All samples shown in table 7 were aged headliner substrates (stored in a plant environment fully exposed to ambient air for 6 months).

TABLE 7

| | | Example 11 | Example 12 |
|---|---|---|---|
| | | (15 gsm | (30 gsm |
| | Comparative | Activated | Activated |
| | Example 8 | Carbon, A- | Carbon, A and |
| | (No Catch | Side Catch | B side Catch |
| | Layer) | Layer only) | Layers) |
| Formaldehyde | 289 | 297 | 122 |
| Acetaldehyde | 2754 | 2448 | 444 |
| Acetone | 0 | 0 | 0 |
| Propaldehyde | 242 | 353 | 0 |
| Benzaldehyde | 257 | 70 | 0 |
| Isovaleraldehyde | 110 | 0 | 0 |
| Acrolein | 52 | 49 | 50 |
| Butyraldehyde | 0 | 0 | 0 |

Referring now to Table 7 above, Examples 11 and 12, which include at least one catch layer, significantly reduce VOC emissions over Comparative Example 8. Further, the two catch layers of Example 12, with higher levels of activated carbon in each layer, more effectively reduce VOC emissions than the single catch layer of Example 11.

The general construction of the composite foam article of the headliner substrate (sandwich structure) of Example 13 is shown in FIG. 1. Comparative Example 9 is similar to Example 13 but does not include a catch layer. Example 15 and Comparative Example 10 are 6 mm board. Referring now to Table 9 below, the composite foam article of Example 15, which includes the catch layer, demonstrates excellent strength and stiffness relative to Comparative Example 10.

Table 8 below describes the reduction in VOCs which is achieved with the composite foam article of Example 13 relative to the VOC emissions of Comparative Example 9. The VOC testing is conducted in accordance to the method set forth above (65° C., 2 hours, 100 L bag). Referring now to Table 8 below, the results generated are set forth in μg/m³.

TABLE 8

| | | Example 13 |
|---|---|---|
| | | (30 gsm |
| | Comparative | Activated |
| | Example 9 | Carbon, A and |
| | (No Catch | B side Catch |
| | Layer) | Layers) |
| Formaldehyde | 21 | 0 |
| Acetaldehyde | 21 | 0 |
| Acrolein | 261 | 38 |
| Acetone | 37 | 0 |
| Propionaldehyde | 88 | 0 |
| Total aldehydes and | 476 | 38 |
| ketones | | |

The catch layers of the composite foam article of Example 13 include activated carbon from Calgon Carbon ground to about 150 μm mean diameter. In Table 8, the headliner substrate samples were stacked on top of each other and stretch-wrapped and stored for 6 months. Referring now to Table 8 above, Example 13, which includes at least two catch layers, significantly reduce VOC emissions over Comparative Example 9.

The general construction of the composite foam article of the headliner substrate (sandwich structure) of Example 14 is shown in FIG. 1. Comparative Example 9 is similar to Example 14 but does not include a catch layer. Example 14 and Comparative Example 9 are 6 mm board. Referring now to Table 9 below, the composite foam article of Example 14, which includes the catch layer, demonstrates excellent strength and stiffness relative to Comparative Example 9. The results of Table 9 are tested according to Honda HES 8320Z test method.

TABLE 9

| Strength | F Max (N) at 23° C. | F Max (N) at 80° C. |
|---|---|---|
| Example 14 | 38.8 | 24.7 |
| Comparative | 35.8 | 25.2 |
| Example 9 | | |
| Stiffness | Stiffness (N/mm) at 23° C. | Stiffness (N/mm) at 80° C. |
| Example 14 | 18.7 | 14.0 |
| Comparative | 18.6 | 14.4 |
| Example 9 | | |

It is to be understood that the appended claims are not limited to express any particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the instant disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the instant disclosure, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The instant disclosure has been described in an illustrative manner, and it is to be understood that the terminology which has been used is intended to be in the nature of words of description rather than of limitation. Obviously, many modifications and variations of the instant disclosure are possible in light of the above teachings. It is, therefore, to be understood that within the scope of the appended claims, the instant disclosure may be practiced otherwise than as specifically described.

1. A composite foam article comprising:
a foam core layer presenting a first surface and a second surface facing opposite said first surface;
a first polymeric bonding layer disposed on said first surface,
one or more first reinforcing layers comprising a plurality of fibers and a polymeric binder disposed on said first polymeric bonding layer, and
a first polymeric containment layer disposed on said one or more first reinforcing layers;
a second polymeric bonding layer disposed on said second surface,
one or more second reinforcing layers comprising a plurality of fibers and a polymeric binder disposed on said second polymeric bonding layer, and
a second polymeric containment layer disposed on said one or more second reinforcing layers; and
at least one catch layer comprising particles of carbon having a surface area of greater than about 300 m²/g, said at least one catch layer dispersed in and/or disposed between any of said aforementioned layers.

2. The composite foam article set forth in claim 1, wherein said catch layer comprises particles of carbon in an amount of from about 2 to about 100, g/m².

3. The composite foam article set forth in claim 1, wherein said particles of carbon have:
a mean particle size of from about 5 to about 1,000, μm; and/or
a surface area of from about 500 to about 3,000, m²/g.

4. The composite foam article set forth in claim 1, wherein said catch layer further comprises at least one small molecule scavenger selected from zeolite, carbohydrazide, ammonium chloride, functionalized polyols, and urea.

5. The composite foam article set forth in claim 4, wherein said catch layer further comprises at least one small molecule scavenger selected from carbohydrazide and urea.

6. The composite foam article set forth in claim 1, wherein the foam core layer comprises semi-rigid polyurethane foam and the composite foam article has an air flow resistance of greater than about 250 mks rayls (Pas/m) when tested in accordance with ASTM C522.

7. (canceled)

8. The composite foam article set forth in claim 1, wherein said first polymeric bonding layer and/or said second polymeric bonding layer:
is formed with polymeric film and/or powder; and
comprises high density polyethylene.

9. (canceled)

10. The composite foam article set forth in claim 1, wherein said first polymeric containment layer and said second polymeric containment layer each respectively comprise at least one polymer selected from polyethylene, polypropylene, and polyethylene terephthalate.

11. The composite foam article set forth in claim 1, wherein:
the foam core layer comprises semi-rigid polyurethane foam having a compression force deflection at 10% deflection of from about 10 to about 110, psi when tested in accordance with ASTM 3574-D; and
said foam core layer has a thickness of from about 3 mm to about 12 mm or from about 10 mm to about 26 mm.

12. (canceled)

13. The composite foam article set forth in claim 1, wherein the foam core layer comprises flexible polyurethane foam having an IFD at 25% deflection of from about 100 to about 2,000 N/314 cm³, when tested in accordance with ASTM 3574-D.

14. The composite foam article set forth in claim 1, wherein said at least one catch layer is further defined as a first catch layer and a second catch layer, wherein said first and second catch layers are compositionally the same or different.

15. The composite foam article set forth in claim 1, wherein:
said at least one catch layer includes a first catch layer, and said first catch layer is disposed between said first reinforcing layer and said first polymeric containment layer; and/or
said at least one catch layer includes a second catch layer, and said second catch layer is disposed between said second reinforcing layer and said second polymeric containment layer.

16. A vehicular component selected from a headliner, a sun shade, a sun visor, a rear seat back panel, a package tray, or a load floor comprising said composite foam article set forth in claim 1.

17. A method of making a composite foam article, said method comprising the steps of:
positioning a blank in a heating device, the blank comprising:
a foam core layer presenting a first surface and a second surface facing opposite said first surface;
at least one catch layer comprising particles of carbon;
at least one reinforcing layer comprising a plurality of fibers and a polymeric binder; and
heating the blank at a temperature above the melting point of the polymeric binder to cause the polymer to melt and the layers of the composite foam article to adhere to one another.

18. The method set forth in claim 17 further comprising the step of molding the blank into a pre-determined shape.

19. The method set forth in claim 18, wherein the step of positioning a blank in a heating device is further described as laminating a blank at a temperature of from about 150 to about 250, ° C.

20. The method set forth in claim 17 further comprising at least one polymeric bonding layer and/or at least one polymeric containment layer.

21. The method set forth in claim 17, wherein:
the composite foam article comprises at least two polymeric bonding layers, at least two reinforcing layers, and at least two polymeric containment layers;
the composite foam article comprises at least two reinforcing layers; and
the composite foam article comprises at least two catch layers.

22. (canceled)

23. (canceled)

24. The method set forth in claim 17, wherein the heating step causes a first reinforcing layer to be adhered by the polymer to the first surface of the foam core and a second reinforcing layer to be adhered by the polymer to the second surface of the foam core layer.

25. (canceled)

26. (canceled)

27. A composite foam article comprising:
a polyurethane foam layer presenting a first surface and a second surface facing opposite said first surface;
a polymeric bonding layer disposed on said first surface;
a catch layer comprising particles of carbon having a surface area greater than about 500 m²/g disposed on said polymeric bonding layer;
a polymeric containment layer disposed on said catch layer; and
a non-woven, woven, leather, or vinyl layer disposed on said second surface.

28. The composite foam article set forth in claim 27, wherein said catch layer comprises particles of carbon in an amount of from about 2 to about 100, g/m².

29. The composite foam article set forth in claim 27, wherein said particles of carbon have:
a mean particle size of from about 5 to about 1,000, μm; and/or
a surface area of from about 500 to about 3,000, m²/g.

30. The composite foam article set forth in claim 27, wherein said catch layer further comprises at least one small molecule scavenger.

31. The composite foam article set forth in claim 27, wherein said polymeric containment layer comprises a polymer selected from polyethylene and polypropylene.

32. The composite foam article set forth in claim 27, wherein said polyurethane foam layer comprises a flexible or viscoelastic polyurethane foam.

33. The composite foam article set forth in claim 27, wherein said non-woven, woven, leather, or vinyl layer is flame bonded to said second surface.

34. (canceled)

35. An automotive seat comprising the composite foam article set forth in claim 27.
